(19) United States
(12) Patent Application Publication
(10) Pub. No.: US 2010/0077361 A1
(43) Pub. Date: Mar. 25, 2010

(54) Method of displaying multiple points of interest on a personal navigation device

(76) Inventor: Andrew Watkins, Auckland (NZ)

Correspondence Address: NORTH AMERICA INTELLECTUAL PROPERTY CORPORATION, P.O. BOX 506, MERRIFIELD, VA, 22116, US

(21) Appl. No.: 12/236,507

(22) Filed: Sep. 24, 2008

(51) Int. Cl. G06F 3/033; G06F 3/048

(52) U.S. Cl. 715/863; 715/846

(57) ABSTRACT

A method of displaying points of interest in a personal navigation device includes displaying a map on a display of the personal navigation device, receiving touch input at a touched position of the display, and searching an area within a search radius of the touched position for points of interest. The method also includes displaying points of interest located in the area within the search radius, where the found points of interest are represented by icons connected to their locations on the map with a line extending out from the touched position, and spreading out the icons around the touched position to separate the icons from each other.

### BACKGROUND OF THE INVENTION

1. Field of the Invention

The invention relates to a method of displaying multiple points of interest on a personal navigation device, and more particularly, to a method for spreading out closely located points of interest to create a flower shape surrounding a selected position.

2. Description of the Prior Art

Global Positioning System (GPS) based navigation devices are well known and are widely employed as in-car navigation devices. Common functions of a navigation device include providing a map database for generating navigation instructions that are then shown on a display of the navigation device. These navigation devices are often mounted on or in the dashboard of a vehicle using a suction mount or other mounting means.

The term “navigation device” refers to a device that enables a user to navigate to a pre-defined destination. The device may have an internal system for receiving location data, such as a GPS receiver, or may merely be connectable to a receiver that can receive location data. The device may compute a route itself, or communicate with a remote server that computes the route and provides navigation information to the device, or a hybrid device in which the device itself and a remote server both play a role in the route computation process. Personal GPS navigation devices are not permanently integrated into a vehicle but instead are devices that can readily be mounted in or otherwise used inside a vehicle. Generally (but not necessarily), they are fully self-contained—i.e. include an internal GPS antenna, navigation software and maps and can hence plot and display a route to be taken.

One useful feature of personal navigation devices is the ability to list nearby points of interest. In rural areas, points of interest may be spread out far from each other, and can easily be shown on the display of the personal navigation device. However, when traveling through cities or other areas where there are many points of interest in close proximity to one another, there can be tens of points of interest located very close together. It is difficult to clearly show multiple points of interest that are in very close proximity to each other on the display of a personal navigation device. To deal with this problem, the prior art has used several different approaches for presenting information about points of interest to users of personal navigation devices.

One method used in the prior art is assigning different priority levels to different types of points of interest. For instance, an office building can be given a low priority while a hospital or a tourist attraction can be given higher priority. Once the priority levels have been established, the personal navigation device can be set to only display points of interest having a priority level equal or greater than a minimum priority. Otherwise, if there are still many points of interest meeting the minimum priority level, the personal navigation device will display only the points of interest with the greatest priority level.

One problem with the traditional approach to displaying points of interest is that if several points of interest occur at the same location or nearby locations, only one type of point of interest icon is drawn, which will be the icon representing the point of interest having the highest priority level. Another related problem is if a point of interest has been selected as a target destination for a user's trip, it is still not shown on the map if this type of point of interest was not enabled or not given high enough priority.

In addition, it is not often possible for users to narrow down categories to a finer granularity of point of interest types, such as selecting curry houses within the restaurant category, or selecting specific chains such as Starbucks™ within the coffee shop category.

Other problems come when the areas displayed on the map change when a user continues driving. As the map point of view changes, points of interest will appear and disappear from the map as their relative positions and priorities vary over time. Having icons constantly appear and disappear can be distracting to users.

Many personal navigation device manufacturers include more points of interest on a map than necessary for the average user because they want the user to appreciate all of the points of interest that the personal navigation device displays. However, most of the time, users are not interested in many of these points of interest. For example, restaurants, Automated Teller Machines (ATMs), etc. are only of interest when you need them, and are not required for every day driving.

After points of interest are displayed on the map, the user may find out more information about one of the points of interest by selecting it. However, if the point of interest that they are interested in is not shown as one of the displayed types of points of interest, they do not have this option. Instead, they may need to zoom in and move the map around in order to display the point of interest that they know is enabled. This may cause confusion as to why they are not able to find the specific point of interest on the map when they know that the point of interest is actually there.

Another problem comes when the user touches a map at a specific location containing multiple points of interest. In this case, the personal navigation device cannot tell which point of interest the user is interested in, and cannot show them the correct location details.

### SUMMARY OF THE INVENTION

It is therefore one of the primary objectives of the claimed invention to provide a method for displaying points of interest on a personal navigation device in order to clearly display multiple points of interest that are located within a selected search area.

According to an exemplary embodiment of the claimed invention, a method of displaying points of interest in a personal navigation device is disclosed. The method includes displaying a map on a display of the personal navigation device, receiving touch input at a touched position of the display, and searching an area within a search radius of the touched position for points of interest. The method also includes displaying points of interest located in the area within the search radius, where the found points of interest are represented by icons connected to their locations on the map with a line extending out from the touched position, and spreading out the icons around the touched position to separate the icons from each other.

It is an advantage that the present invention provides a clear way to display multiple points of interest, even when the points of interest are located in very close proximity to each other. Icons representing the points of interest will automatically spread out so that the points of interest located within the search radius can easily be seen.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a map showing roads and points of interest.

FIG. 2 illustrates another map showing a search for points of interest within a radius of a touched position of the map.

FIG. 3, which illustrates another map showing a search for points of interest within another radius of a touched position of the map.

FIG. 4 is a flowchart illustrating the present invention method for displaying points of interest in a personal navigation device according to the present invention method.

### DETAILED DESCRIPTION

The present invention aims to provide information about points of interest to a user in an unobtrusive manner. To accomplish this, by default very few point of interest icons will be shown on the map of the personal navigation device. Those points of interest that are shown should be of genuine interest, such as landmarks, tourist attractions, etc.

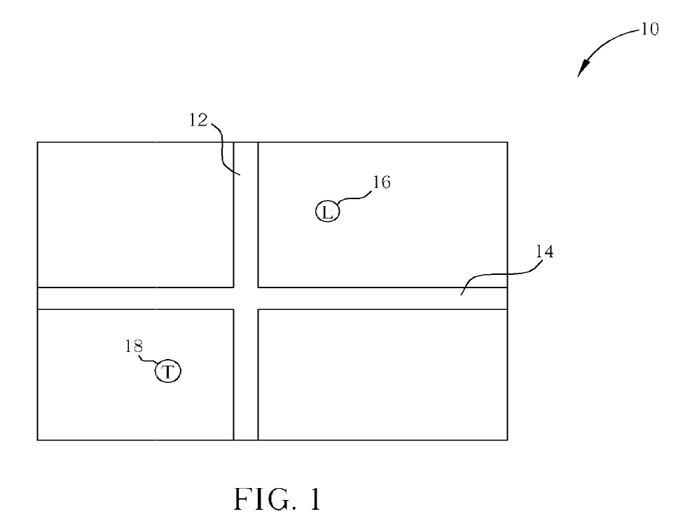

Please refer to FIG. 1. FIG. 1 illustrates a map 10 showing roads 12 and 14 and points of interest 16 and 18. Point of interest 16 corresponds to a landmark, whereas point of interest 18 corresponds to a tourist attraction. If the user wishes to find out more information about either of the points of interest 16 and 18, the user can touch or select one of them to see additional information. If the user touches a portion of the map 10 that does not have any points of interest shown, a search can be performed for nearby points of interest. The present invention only requires the user to touch a screen on which the map 10 is displayed. It is not necessary to use a mouse or other pointing device to move a cursor to a desired position.

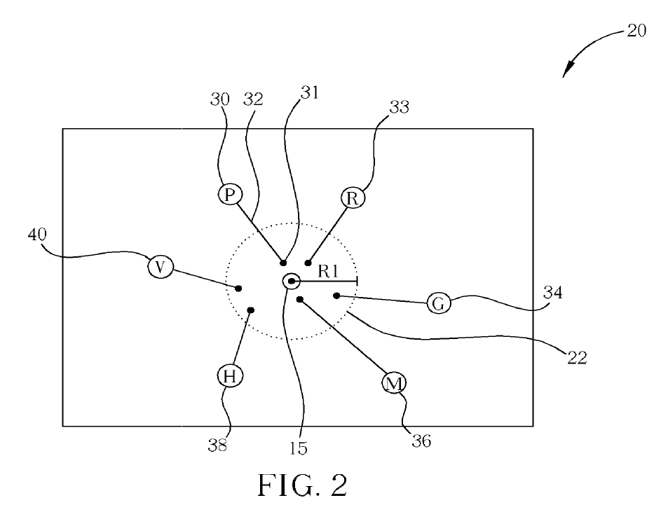

Please refer to FIG. 2. FIG. 2 illustrates another map 20 showing a search for points of interest within radius R1 of a touched position 15 of the map 20. When the user touches the touched position 15, an area 22 within the radius R1 is searched for points of interest located within the area 22. If several points of interest are found within the area 22, each point of interest is represented as an icon attached to its location point by a line. In order to make the icons easier to see, the icons are fanned out around the user's finger so that the user sees a cluster of spread out point of interest icons. Referring back to FIG. 2, icon 30 represents a parking lot located at location point 31. Icon 30 is attached to location point 31 by line 32. Other similar icons are also shown in FIG. 2, including icon 33 representing a restaurant, icon 34 representing a golf course, icon 36 representing a museum, icon 38 representing a hospital, and icon 40 representing a visitor's center. Although each of the icons 30, 33, 34, 36, 38, 40 has a corresponding location point and line connecting the icon to the location point, only the location point 31 and line 32 corresponding to icon 30 are numbered for enhancing the clarity of FIG. 2.

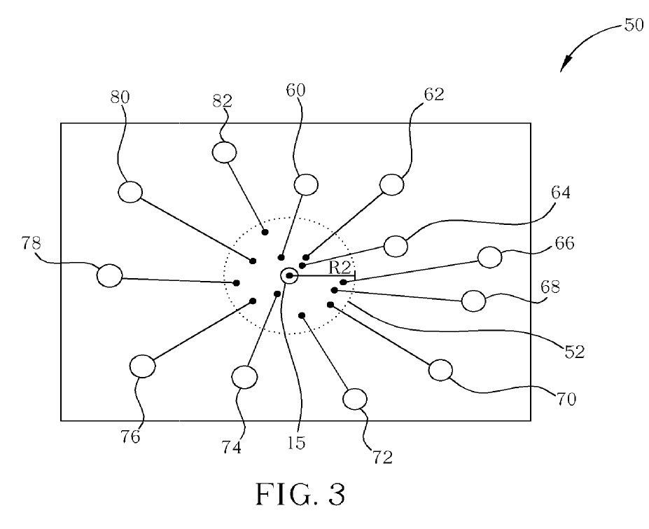

If the user continues to touch the screen at the touched position 15, the search process will repeat using a slightly larger search radius. Please refer to FIG. 3, which illustrates another map 50 showing a search for points of interest within radius R2 of a touched position 15 of the map 50. Since the user continued to touch the touched position 15, the radius R1 increased to become the larger radius R2. As the search radius increases, the area 52 being searched increases, and the number of icons shown in the map 50 will also increase until the map is showing a maximum number of icons (such as 50), until the lines connecting the icons to their location points becomes too long for the icons to be shown on the map 50, or until there are no longer any further points of interest found within the visible map 50. In FIG. 3 icons 60, 62, 64, 66, 68, 70, 72, 74, 76, 78, 80 are all shown as having corresponding location points within area 52. As the number of icons increases, the icons will place themselves slightly farther from the user's finger so that the cluster of icons starts to become a cloud or a flower. The icons can be displayed in a symmetrical pattern or in an irregular pattern around the touched position 15.

When the cluster of icons gets too close together, some icons will move farther away from the touched position 15 in order to stagger the icons and allow for more icons to be shown. When this occurs, icons corresponding to location points that are farther from the touched position 15 will move farther out than icons that correspond to location points closer to the touched position 15. For example, in FIG. 3, icon 64 is located closer to the touched position 15 than icons 62 and 66 since the location point corresponding to icon 64 is closer than the location points corresponding to icons 62 and 66.

In general, the nature of the present invention search for points of interest is that icons will gradually appear as the user continues to press the touched position 15, starting with those icons nearest the touched position 15 and moving out as the search radius increases. Once the users finger is removed from the screen and the touched position 15 is no longer being pressed, the displayed icons are shown for a short period of time. This period of time is long enough for users to inspect the displayed points of interest and tap on specific icons to get additional details about the selected point of interest, such as the detailed address and the phone number of the selected point of interest. In addition to getting more details about the selected point of interest when tapping on an icon, the user can also be presented with the option of receiving navigation instructions that take the user directly to the selected point of interest. If the user selects this option, the user can be guided to the point of interest directly without having to enter another address manually. After a timeout period, the icons will gradually fade away or will pop like bubbles. When the screen is first touched, a graphical context menu will also appear. This provides some key functions that will operate on the selected position or the selected point of interest. Some of these functions include Search Nearby, Online Search Nearby, Navigate To, Set As Start, Avoid, Re-center, etc.

The key to the usability of this invention lies in the quality of the graphics and animation. Each icon that appears needs to be placed in an appropriate position on the screen. Ideally, the icon should be shown on a radial line centered on the touched position 15 and passing through the location point of the point of interest. If the locations of two points of interest are close together or are on the same radius, the icons will need to adjust their positions to allow both to be shown. This positioning can be achieved by having all of the other icons shuffle along slightly. This motion can also be animated so each icon appears in turn and then shifts along to allow new icons to appear. It is important that the icons do not suddenly jump around, and instead they should move like particles in water spreading out to use the space optimally.

The underlying layout positioning algorithm can be described as follows. If there are no space constraints for the icons, a construction line can be drawn from the touched position 15 to the location point of the point of interest and continued radially a short distance to position the icon. If two icons overlap or the lines would cross each other, then the length of the line connecting the location point of the point of interest and its corresponding icon can be lengthened radially. The point of interest that is farthest away from the touched position 15 should be chosen to have its corresponding line lengthened. The farther away the point of interest is from the touched position 15, the longer the line can be. Otherwise, a repulsive factor can be applied to each icon so that they will separate themselves evenly. This may require the icons to move radially towards or from the touched position 15 or move tangentially around the touched position 15.

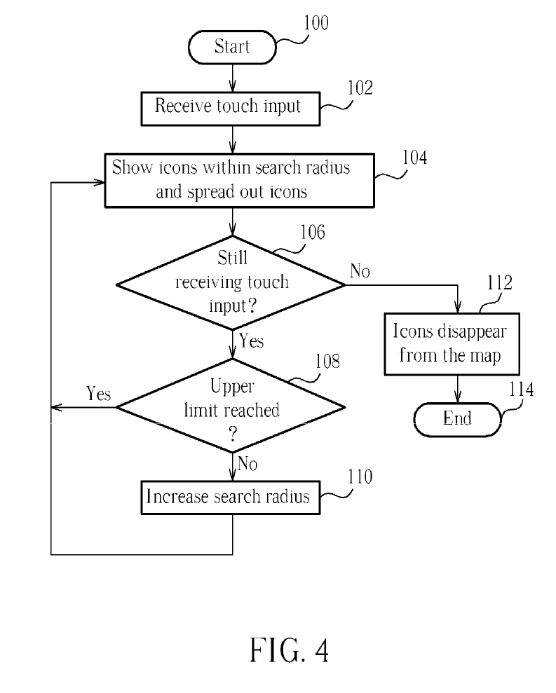

Please refer to FIG. 4. FIG. 4 is a flowchart illustrating the present invention method for displaying points of interest in a personal navigation device according to the present invention method. Steps contained in the flowchart will be explained below.

Step 100: Start.

Step 102: Receive touch input from the user at the touched position 15.

Step 104: Show icons within the current search radius and spread out displayed icons to make them easier to see.

Step 106: Determine if touch input is still being received at the touched position 15. If so, go to step 108. If not, go to step 112.

Step 108: Determine if the upper limit for displayed icons has been reached. The upper limit can be met by a maximum number of icons (such as 50) being displayed on the map, by the lines connecting the icons to their location points becoming too long for the icons to be shown on the map, or when there are no longer any further points of interest found within the visible map. If the upper limit has been reached, go back to step 104. If the upper limit has not been reached, go to step 110.

Step 110: Increase the search radius. Go back to step 104.

Step 112: Icons gradually disappear from the map after a predetermined period of time has elapsed since the user stopped pressing the touched position 15.

Step 114: End.

The present invention also provides a way to restrict the search for points of interest within the search radius of the touched position 15 to selected types of points of interest, and to only display icons corresponding to the selected types of points of interest. These selected types of points of interest can also be given priority levels, such that additional types of points of interest with lower priority levels are selected for the search as the touch input continues to be received.

In summary, the present invention provides a clear way to display multiple points of interest, even when the points of interest are located in very close proximity to each other. Icons representing the points of interest will automatically spread out so that the points of interest located within the search radius can easily be seen.

Those skilled in the art will readily observe that numerous modifications and alterations of the device and method may be made while retaining the teachings of the invention.

What is claimed is:

1. A method of displaying points of interest in a personal navigation device, the method comprising:
displaying a map on a display of the personal navigation device;
receiving touch input at a touched position of the display;
searching an area within a search radius of the touched position for points of interest;
displaying points of interest located in the area within the search radius, wherein the found points of interest are represented by icons connected to their locations on the map with a line extending out from the touched position; and
spreading out the icons around the touched position to separate the icons from each other.

2. The method of claim 1, wherein the spread out icons surround the touched position.

3. The method of claim 1, wherein as the number of points of interest located in the area within the search radius increases, icons representing the points of interest spread out away from the touched position.

4. The method of claim 3, wherein points of interest farther from the touched position are represented by icons connected to their locations on the map with longer lines.

5. The method of claim 1, wherein as the touch input is received at the touched position for an increasingly longer time period, the search radius correspondingly increases, and additional icons corresponding to points of interest located in the area within the search radius are displayed.

6. The method of claim 5 further comprising stopping displaying additional icons when the number of displayed icons is greater than an upper threshold.

7. The method of claim 5 further comprising stopping displaying additional icons when the search radius is greater than an upper threshold.

8. The method of claim 1 further comprising displaying icons for a predetermined time period after the touch input is no longer received.

9. The method of claim 8 further comprising controlling icons to fade away gradually after the predetermined time period has elapsed.

10. The method of claim 8 further comprising controlling icons to pop and disappear after the predetermined time period has elapsed.

11. The method of claim 1, wherein positions of icons shift to avoid overlapping with other icons.

12. The method of claim 11, wherein the icons shift outward radially and increase the length of the lines connecting the icons to their respective locations on the map.

13. The method of claim 11, wherein the icons shift tangentially for maintaining the length of the lines connecting the icons to their respective locations on the map.

14. The method of claim 1, wherein positions of icons shift to prevent the lines that connect icons to their respective locations on the map from intersecting with each other.

15. The method of claim 14, wherein the icons shift outward radially and increase the length of the lines connecting the icons to their respective locations on the map.

16. The method of claim 14, wherein the icons shift tangentially for maintaining the length of the lines connecting the icons to their respective locations on the map.

17. The method of claim 1 further comprising restricting the search for points of interest within the search radius of the touched position to selected types of points of interest, and only displaying icons corresponding to the selected types of points of interest.

18. The method of claim 17, wherein additional types of points of interest are selected for the search as the touch input continues to be received.

19. The method of claim 1 further comprising:
receiving touch input directed to a displayed icon; and
displaying additional information about the point of interest corresponding to the displayed icon for which touch input has been received.

20. The method of claim 1, wherein the icons are displayed in an irregular pattern around the touched position.
